(19) United States
(12) Patent Application Publication
(10) Pub. No.: US 2002/0156759 A1
(43) Pub. Date: Oct. 24, 2002

(54) System for transmitting messages

(76) Inventor: Eugenio Carlos Ferrao dos Santos, Brooklyn, NY (US)

Correspondence Address: ST. ONGE STEWARD JOHNSTON & REENS, LLC, 986 BEDFORD STREET, STAMFORD, CT, 06905-5619, US

(21) Appl. No.: 09/838,071

(22) Filed: Apr. 20, 2001

(51) Int. Cl. G06F 7/00

(52) U.S. Cl. 707/1

(57) ABSTRACT

The invention relates to a system for transmitting messages selected by a user including a computer, software executing on the computer for displaying a plurality of messages, software executing on the computer for receiving a selected message of at least one of the plurality of messages, and software executing on the computer for forwarding the selected message to a recipient. The plurality of messages include a song, a verbal communication, a prerecorded speech, and combinations thereof. In another embodiment, the invention includes software executing on the computer for prompting an operator that a message needs to be forwarded to the recipient.

### FIELD OF THE INVENTION

The invention relates to a system for transmitting messages selected from a host of messages displayed on a computer and, more particularly, transmitting the selected messages to a recipient using a telecommunicating device.

### BACKGROUND OF THE INVENTION

Voice interface systems, including voice portals, facilitate the use of the Internet by permitting phone users to access information that would otherwise require a computer. Phones are typically more readily available than computers because most people have at least one phone whereas computers are not, although increasingly so, as popular. With the advent of mobile or wireless phones, phones have become even more popular because their lightweight and compact features generally make them more convenient and portable than even the smallest or lightest notebook computer. Usually, the smallest portable computer is more cumbersome than the typical phone or mobile phone. Hence, voice interface systems that provide access to information on the Internet via a phone give phones a tremendous advantage over computers because a user is more likely to have access to a phone than to a computer.

Voice interface systems are known to provide information from the Internet to the phone by translating text to speech. Voice interface systems also permit a caller to send information, such as email messages, by translating speech to text. Known voice interface systems are also generally easy to use and permit computer illiterate callers Internet access, a further advantage of voice interface systems over computers. One typically knows how to operate a phone but this is not necessarily the case when operating a computer.

The Tellme® system operated by Tellme Networks, Inc. of Mountain View, Calif. is a voice application network that combines the telephone and Internet. Tellme operates by providing information, retrieved in real time from the Internet, over the phone to the caller. The system requires a caller to call a Tellme location. Upon Tellme answering the call, the caller chooses from a menu of options, such as weather, sport scores, or stock activity. The Tellme system then accesses the latest information from the Internet in real time and provides it over the phone to the caller by translating text to speech. For frequent callers, voice recognition is disclosed for making the process quicker.

Voice based email systems permit email access to phones and, in particular, mobile or wireless phones. Voice based systems, such as etrieve®, operated by etrieve, Inc. of Hillsboro, Oreg., permit callers to access and read emails and email attachments. The systems operate by translating the email text into voice and transmitting it audibly over the phone to the caller. etrieve® further permits the caller to send email using his/her phone by translating the voice into text and emailing the text.

ShopTalk Networks^{SM} of Chicago, Ill. operates another voice to text system that permits a caller to shop over the Internet using a phone. A caller calls a ShopTalk location and chooses an area of purchase from a menu of options, such as car supplies or groceries. The caller then selects specified information in the area of purchase and instructs the ShopTalk system to email him/her more information regarding the specified information. The caller may also listen to advertisements or special offers made over the phone.

Wireless2Web^{SM} operates another system permitting wireless email access. A caller can receive a text email message on his wireless device and reply to the email by simply speaking the message. The system records the speech so that a recipient may hear the reply as he is logged onto his/her computer.

A disadvantage of the above systems is that there are no personalized greetings or messages unique to a particular sender or recipient of the message. For example, the TelIMe and ShopTalk systems merely retrieve generic, publicly available information for the caller. No where does any reference disclose a prerecorded message being chosen from among a variety of computer displayed prerecorded messages. Also, no reference discloses transmitting a message for a particular occasion and for a particular recipient. Further, no reference discloses a message containing background music or a personalized verbal communication from a sender to a recipient. In addition, no reference discloses displaying a selected message for approval over the computer and then forwarding the message to the recipient via a telecommunication network.

What is desired, therefore, is a system that permits a sender to send a personalized message via computer and telecommunication device. What is also desired is a system that permits a personal message to be sent and capable of including a prerecorded message, a sender's voice, or background music as part of the personal message. What is also desired is a system that permits a sender to view his personal message over the computer for approval prior to sending the message.

### SUMMARY OF THE INVENTION

Accordingly, it is an object of the invention to provide a system that displays a variety of messages from which a user may choose a selection and transmit the selected message to a recipient via a telecommunicating device.

It is another object of the invention to provide a system that permits a user to include user speech and/or a song as part of the selected message he/she transmits to the recipient.

Another object of the invention is to provide a system that permits a user to view his/her selected message for approval prior to being transmitted.

Yet another object of the invention is to provide a system that permits a user to specify a time and a recipient location, such as a phone/facsimile number, to transmit the selected message.

These and other objects of the invention are achieved by a system for transmitting messages selected by a user including a computer, software executing on the computer for displaying a plurality of messages, software executing on the computer for receiving a selection of at least one of the plurality of messages, and software executing on the computer for forwarding the selected message to a recipient. The plurality of messages include a song, a verbal communication, a prerecorded speech, and combinations thereof.

The system further comprises software executing on the computer for receiving an indication of a future time and for forwarding the selected message to the recipient at the specified future time. In addition to time, the system may also comprise software executing on the computer for receiving an indication of the recipient of the selected message, such as a phone/facsimile number, and for forwarding the selected message to the recipient at the specified phone/facsimile number.

The system further comprises a telecommunicating device for forwarding the selected message to the recipient. The telecommunicating device may be a phone having an audio input for a music player and/or an operator's voice.

The system further comprises software executing on the computer for displaying the selected message for approval by the user.

In another embodiment of the invention, the system may comprise software executing on the computer for prompting an operator to forward the selected message to the recipient.

In another aspect of the invention, the system provides a method for transmitting messages selected by a user. The method comprises the steps of displaying a plurality of messages on the computer, receiving a selection of at least one of the plurality of messages, telecommunicating with a recipient, and forwarding the selected message to the recipient. The plurality of messages includes a song, a verbal communication, a prerecorded speech, and combinations thereof.

The method further comprises the step of receiving an indication of a time for forwarding the selected message. The method also comprises the step of receiving an indication of an identity of the recipient.

The method further comprises the step of displaying the selected message and, if satisfactory, receiving an approval of the selected message to be forwarded to the recipient.

The method further includes the step of playing music over a telecommunicating device.

In another aspect of the invention, the method for transmitting messages selected by a user further comprises the step of prompting an operator to forward the selected message to a recipient.

The invention and its particular features and advantages will become more apparent from the following detailed description considered with reference to the accompany drawings.

### BRIEF DESCRIPTION OF THE DRAWINGS

FIG. 1 depicts the system in accordance with the invention for automatically transmitting messages selected by a user.

FIG. 2 depicts another embodiment for transmitting messages including software for prompting an operator to forward selected messages.

FIG. 3 depicts a method for automatically transmitting messages selected by a user.

FIG. 4 depicts another aspect of the method for transmitting messages selected by a user by prompting an operator to forward selected messages.

### DETAILED DESCRIPTION OF THE DRAWINGS

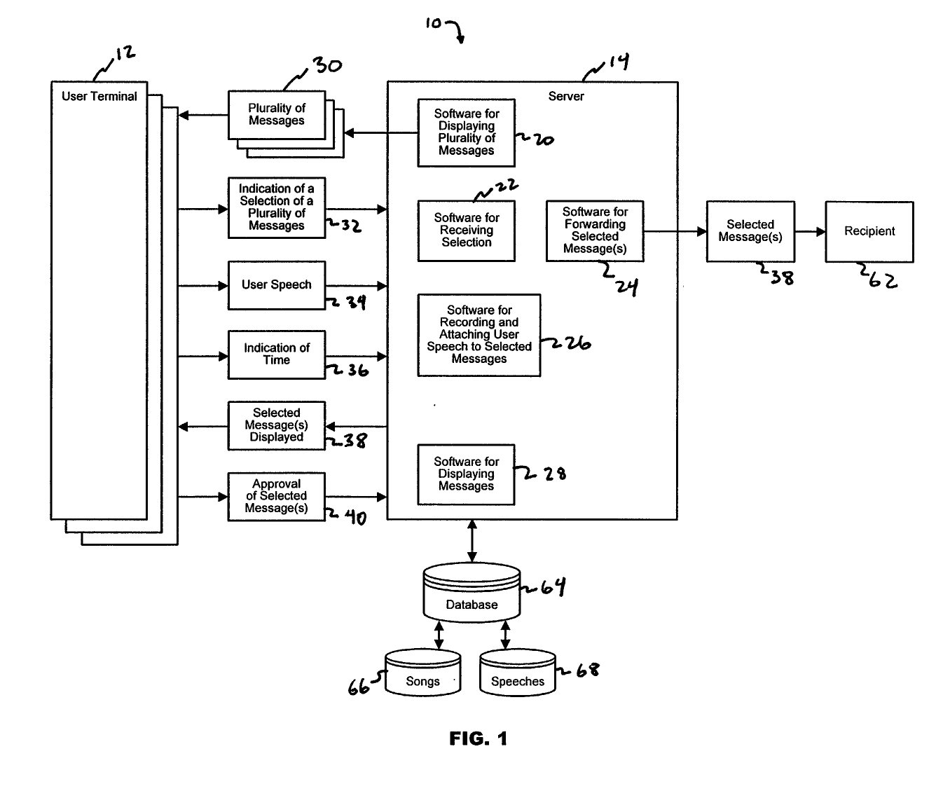

FIG. 1 depicts system 10 for transmitting messages selected by a user in accordance with the invention. System 10 automatically transmits selected messages to a recipient via telecommunicating device after a user makes a selection using his/her computer. System 10 includes computer 14, software 20 executing on computer 14 for displaying a plurality of messages, software 22 executing on the computer for receiving a selection of at least one of the plurality of messages, and software 24 executing on the computer for forwarding the selected message to a recipient.

Computer 14 includes any known or novel computer capable of displaying a plurality 30 of various messages for selection by a user operating user terminal 12. User terminal 12 is also a computer and is in communication, either via a hardwire or wireless connection, with computer 14. In one embodiment, the connection is an Internet connection.

Plurality 30 of messages comprises a menu of messages that relate to a broad range of events, days, holidays, celebrations, sympathies, and announcements. Plurality of messages 30 further includes any occasion that people may desire to send a message. Generally, plurality 30 of messages cover all the events that card manufacturers cover in their display of cards in a store. For example, these include religious celebrations, birthdays, national holidays, anniversaries, grief or sorrow, congratulatory events, or any other special event.

Plurality 30 of messages is stored on database 64 and is retrieved by computer 14 for display. In addition to textual messages, plurality 30 of messages may also include songs and verbal speech, which may be supplied to or in connection with database 64 by song database 66 and speech database 68.

Software 20 executing on computer for displaying plurality 30 of messages represents the messages in any format for display, such as table form being organized according to calendar day, events, and being alphabetically listed or any manner of organizing the plurality 30 of messages. Another manner for displaying plurality 30 of messages is a keyword or index search that retrieves messages having the specified search term.

After a user operating user terminal 12 views the plurality of messages, he/she makes a selection 32 of at least one message to be sent to a specified recipient 62, which is received by software 22 executing on the computer for receiving selection 32.

In addition to receiving a selection from a plurality of messages, system 10 may optionally prompt the user to provide an indication of a recipient's identity, indication of a time or time range 36 for forwarding the selected message to recipient 62, and a verbal communication 34 to recipient 62. An indication of a recipient's identity includes a name or phone number. Time 36 includes the best times to try to reach recipient 62. Verbal communication 34 includes a personal greeting/speech that is spoken by the user and recorded by software 26 for recording and attaching user speech 34 to the selected message to be sent to recipient 62.

After receiving all information from the user, including selected message 38 and, optionally, verbal speech 34, software 28 for displaying messages displays selected message 38 on computer 14 for user approval. Software 28 for displaying messages is not required for system 10 to function properly and may be deleted in other embodiments. After viewing selected message 38, user thereafter either cancels the selection or confirms approval. The user cancels or approves 40 the selected message by selecting a “cancel” or “approve” button on the computer screen.

Once approved, software 24 executing on the computer for forwarding selected message 38 automatically forwards the message to recipient 62 via a telecommunicating device, such as a phone. System 10 accomplishes this by converting the text of selected message 38 to voice and forwarding the message to recipient 62. If verbal speech 34 is provided by the user, system 10 plays the previously recorded user speech 34 contemporaneously with selected message 38.

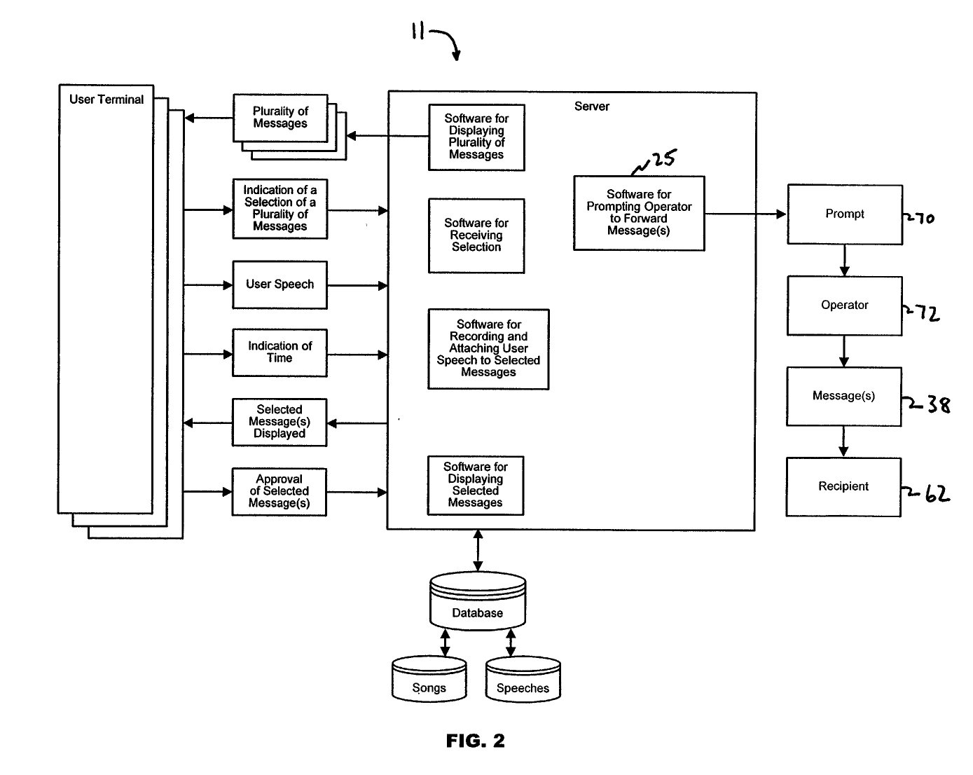

FIG. 2 depicts another embodiment of the system 11 for transmitting messages selected by a user. System 11 differs from system 10 of FIG. 1 in that an operator forwards selected message 38 to recipient 62. Hence, system 11 does not operate automatically, as opposed to the automatic system 10 depicted in FIG. 1.

System 11 includes all the limitations of system 10 except that software 24 executing on the computer for forwarding selected message is replaced with software 25 for prompting operator 72 to forward selected message 38 to recipient 62. Software 25 transmits prompt 70, or signal, to operator 72 that message 38 needs to be forwarded. Prompt 70 may be in the form of a phone call, alarm, email, facsimile, or some other signal sent by system 11 to operator 72 to indicate that a message needs to be forwarded.

After being prompted, operator 72 thereafter telecommunicates with recipient 62, such as via a telecommunicating device, to ensure the proper recipient has been reached. Operator 72 then instructs recipient 62 to stay on the line to listen to selected message 38. Operator 72 then forwards selected message 38.

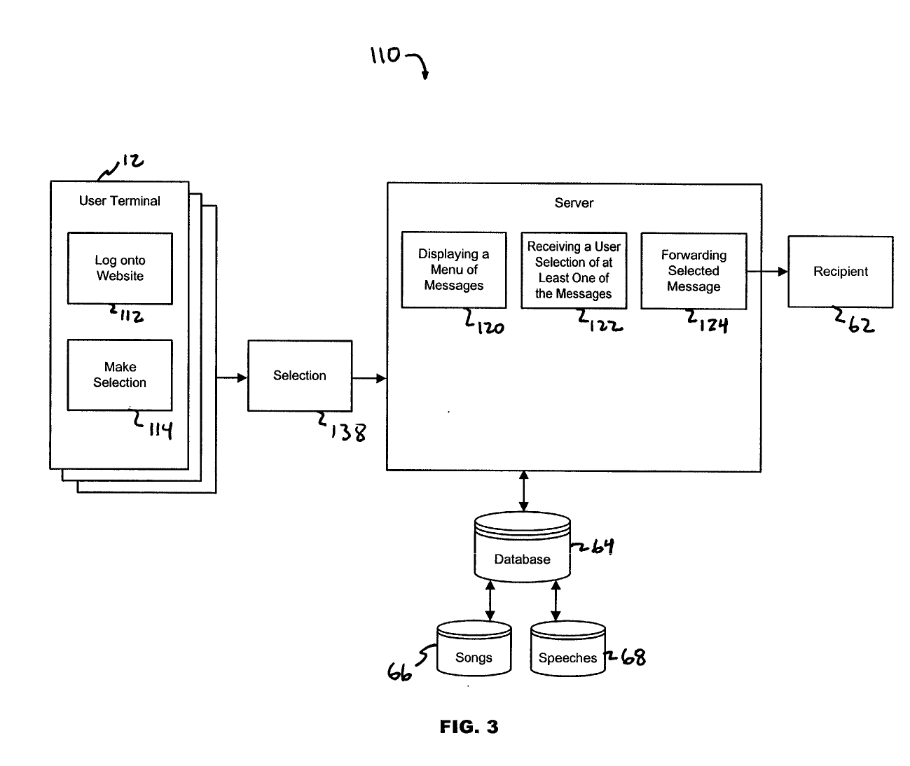

FIG. 3 depicts method 110 for transmitting messages selected by a user. Method 110 automatically transmits selected messages to a recipient via a telecommunicating device after a user makes a selection using his/her computer. Method 110 includes a user connecting 112 to computer 14. The user can connect to computer 14 by using user terminal 12 to communicate with computer 14. The communication may further be through an Internet connection. Method 110 further includes displaying 120 a plurality of messages, receiving 122 a user selection of at least one of the plurality of messages to be forwarded to recipient 62, and forwarding 124 the selected message to recipient 62.

After the user connects 112 to computer 14, method 110 displays 120 a plurality of messages on computer 14. The user views the displayed messages and selects 114 at least one message to be forwarded to recipient 62. The user selection 138 is received 122 by computer 14 and method 110 automatically forwards 124 the selected message to recipient 62. Optionally, method 110 may include forwarding the selected message at a specified time to a specified recipient, in which case the user forwards additional information to computer 14.

Once the selected message is received, method 110 automatically forwards 124 the selected message to recipient 62 via a telecommunicating device, such as a phone. Should the time to forward 124 the selected message be far in advance of the current time, method 110 may store the selected message on database 64 for later retrieval. In addition, the selected message may further include a song or verbal speech.

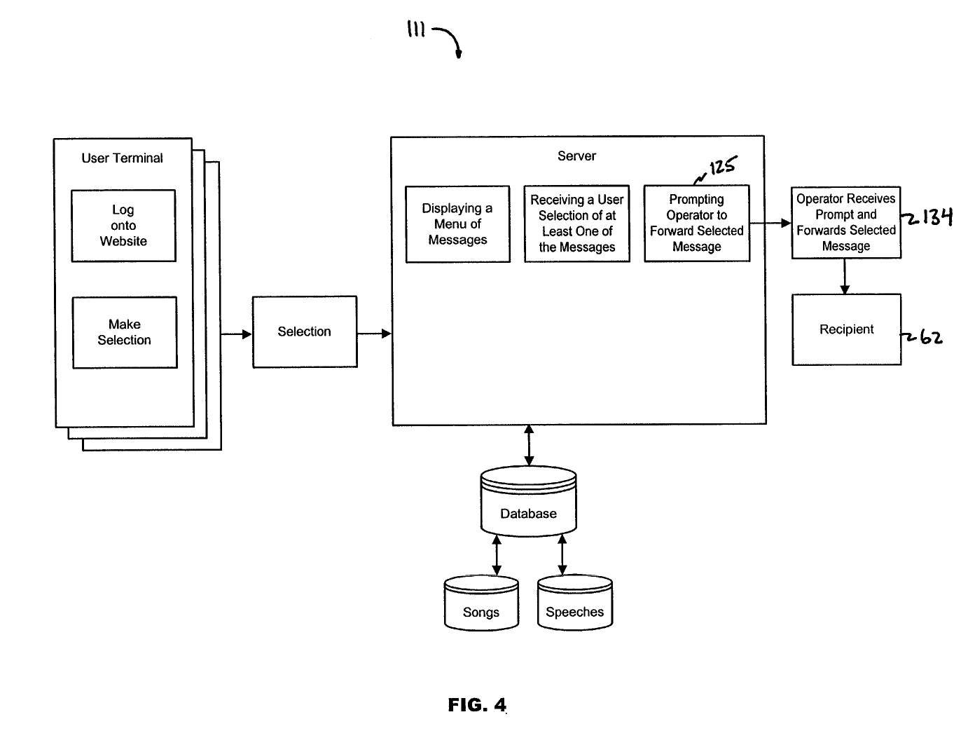

FIG. 4 depicts method 111 for transmitting messages selected by a user. Method 111 differs from method 110 of FIG. 3 in that an operator forwards the selected message. Hence, method 111 does not operate automatically, as opposed to the automatic method 110 depicted in FIG. 3.

Method 111 includes all the limitations of method 110 depicted in FIG. 3 except that the step for automatically forwarding 124 selected messages to recipient 62 is replaced with the step for prompting 125 an operator to forward the selected message.

Prompting 125 the operator may include transmitting an email, phone calling the operator, setting off an alarm, or any other step for signaling an operator that a message needs to be forwarded.

After being prompted, the operator thereafter telecommunicates with recipient 62 to ensure the proper person is receiving the message. Then, operator forwards 134 the selected message to recipient 62.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A system for transmitting messages selected by a user, comprising:
a computer;
software executing on said computer for displaying a plurality of messages, wherein said plurality of messages are selected from the group consisting of a song, a verbal communication, a prerecorded speech, and combinations thereof;
software executing on said computer for receiving a selection of at least one of said plurality of messages from the user; and
software executing on said computer for forwarding said selected message to a recipient.

2. The system according to claim 1, further comprising software executing on said computer for receiving an indication of a future time for forwarding said selected message to the recipient, and wherein said software forwards the message at the indicated future time.

3. The system according to claim 1, further comprising software executing on said computer for receiving an indication of the recipient of said selected message and wherein said selected message is sent to the indicated recipient.

4. The system according to claim 3, wherein said indication of the recipient is a phone number.

5. The system according to claim 1, wherein said plurality of messages are celebratory of a calendar day.

6. The system according to claim 1, wherein said plurality of messages are celebratory of an event.

7. The system according to claim 1, further comprising a telecommunicating device for forwarding said selected message to the recipient.

8. The system according to claim 7, wherein said telecommunicating device includes at least one audio input for a music player.

9. The system according to claim 7, wherein said telecommunicating device includes at least one audio input for an operator's voice.

10. The system according to claim 1, wherein said selected message includes a human voice.

11. The system according to claim 10, wherein said human voice is a sender's voice.

12. The system according to claim 1, further comprising software executing on said computer for displaying said selected message for approval by a user.

13. The system according to claim 12, further including software executing on said computer for receiving an approval of said displayed message.

14. A system for transmitting messages selected by a user, comprising:
a computer;
software executing on said computer for displaying a plurality of messages, wherein said plurality of messages are selected from the group consisting of a song, a verbal communication, a prerecorded speech, and combinations thereof;
software executing on said computer for receiving a selection of at least one of said plurality of messages from the user; and
software executing on said computer for prompting an operator to forward said selected message to a recipient.

15. The system according to claim 14, further comprising software executing on said computer for receiving an indication of a future time for forwarding said selected message to the recipient, and wherein said software forwards the message at the indicated future time.

16. The system according to claim 14, further comprising software executing on said computer for receiving an indication of the recipient of said selected message and wherein said selected message is sent to the indicated recipient.

17. The system according to claim 14, further comprising a telecommunicating device for forwarding said selected message to the recipient.

18. The system according to claim 17, wherein said telecommunicating device includes at least one audio input for a music player.

19. The system according to claim 17, wherein said telecommunicating device includes at least one audio input for an operator's voice.

20. The system according to claim 14, wherein said selected message includes a sender's voice.

21. The system according to claim 14, further including software executing on said computer for displaying said selected message for approval by a sender.

22. A method for transmitting messages selected by a user, comprising the steps of:
displaying a plurality of messages to a user, wherein said plurality of messages are selected from the group consisting of a song, a verbal communication, a prerecorded speech, and combinations thereof;
receiving a selection of at least one of said plurality of messages;
telecommunicating with a recipient; and
forwarding said selected message to the recipient.

23. The method according to claim 22, further comprising the step of receiving an indication of a time for forwarding said selected message to the recipient, and wherein the message is forwarded at the indicated time.

24. The method according to claim 22, further comprising the step of receiving an indication of an identity of the recipient and wherein the message is forwarded to the indicated recipient.

25. The method according to claim 22, further comprising the step of displaying said selected message of at least one of said plurality of messages to the user.

26. The method according to claim 25, further comprising the step of receiving an approval from the user of said displayed selected message of at least one of said plurality of messages.

27. The method according to claim 22, further comprising the step of playing music over a telecommunicating device.

28. A method for transmitting messages selected by a user, comprising the steps of:
displaying a plurality of messages to a user, wherein said plurality of messages are selected from the group consisting of a song, a verbal communication, a prerecorded speech, and combinations thereof;
receiving a selection of at least one of said plurality of messages; and
prompting an operator to forward said selected message to a recipient.

29. The method according to claim 28, further comprising the step of displaying said selected message of at least one of said plurality of messages to the user.

30. The method according to claim 28, further comprising the step of receiving an approval from the user of said displayed selected message of at least one of said plurality of messages.
